(19) United States
(12) Patent Application Publication
(10) Pub. No.: US 2026/0073400 A1
(43) Pub. Date: Mar. 12, 2026

(54) Continually Evolving Subjects Using Machine Learning

(71) Applicant: Oracle International Corporation, Redwood Shores, CA (US)

(72) Inventors: David Mor, Pittsford, NY (US); Prabakar Paulsami, Redwood City, CA (US); Kent Olen Swartz, Leesburg, VA (US); Naveen Thulasidharan, Trivandrum (IN); Nithin Nassar, Trivandrum (IN)

(73) Assignee: Oracle International Corporation, Redwood Shores, CA (US)

(21) Appl. No.: 18/985,230

(22) Filed: Dec. 18, 2024

Related U.S. Application Data
(60) Provisional application No. 63/691,570, filed on Sep. 6, 2024.

(51) Int. Cl. G06Q 30/015; G06N 20/00

(52) U.S. Cl. CPC G06Q 30/015; G06N 20/00

(57) ABSTRACT

Techniques for generating a subject that accurately describes the current content of an electronic conversations are disclosed. A system receives an electronic message associated with a customer and stores the message in association with an electronic conversation. Based on customer rules, context information, and/or conversation content, the system generates a prompt for a machine learning model trained to generate subject lines and/or tags appropriate for the particular customer. The system submits the prompt to the machine learning model to obtain a subject line and/or subject tags that accurately describe(s) the current content of the conversation within a timeframe.

### BENEFIT CLAIMS; RELATED APPLICATIONS; INCORPORATION BY REFERENCE

This application claims the benefit of U.S. Provisional Patent Application 63/691,570, filed Sep. 6, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to electronic messaging systems. In particular, the present disclosure relates to generating subjects that accurately describe the contents of electronic conversations.

### BACKGROUND

Electronic messaging systems may use various forms of communication, such as emails, text messages, chats, social media posts, conversation logs, and the like. An electronic message refers to a unit of communication intended for human interaction. A conversation refers to a collection of related electronic messages exchanged over time. For example, a conversation may include a series of emails on a related topic exchanged between two or more individuals. As another example, a conversation may include a series of messages stored by one or more customer service agents in connection with a customer support ticket. Even if the customer does not personally store messages in the log, this latter example is still considered a conversation because it describes exchanges between the customer, one or more agent(s), and/or one or more other individuals (e.g., technical staff, quality assurance, stakeholders, etc.). The messages in a conversation may be related by a common subject line that includes a string of text describing the topic of the conversation.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a functional block diagram of an example service management architecture in accordance with one or more embodiments;

FIG. 1B illustrates a system block diagram of an example service management system in accordance with one or more embodiments;

FIGS. 2A, 2B, and 2C illustrate an example set of operations for updating electronic conversations with subject lines and/or tags representing the content of the conversations in accordance with one or more embodiments;

FIG. 3 illustrates an example prompt template in accordance with one or more embodiments;

FIG. 4 illustrates a machine learning engine in accordance with one or more embodiments;

FIG. 5 illustrates the operation of a machine learning engine in accordance with one or more embodiments; and

FIG. 6 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. PRACTICAL APPLICATIONS, ADVANTAGES & IMPROVEMENTS
3. SERVICE MANAGEMENT ARCHITECTURE
4. SERVICE MANAGEMENT SYSTEM
5. UPDATING ELECTRONIC CONVERSATIONS WITH SUBJECT LINES AND TAGS REPRESENTING THE CONTENT OF THE CONVERSATIONS
6. EXAMPLE PROMPT TEMPLATE FOR GENERATING SUBJECT LINES
7. MACHINE LEARNING ARCHITECTURE
8. HARDWARE OVERVIEW
9. MISCELLANEOUS; EXTENSIONS

### 1. General Overview

One or more embodiments generate subjects that accurately describe the content of electronic conversations in electronic messaging systems. Over the course of a conversation, the topic of the conversation may substantially diverge from its previous or original topic. Alternatively or additionally, the content of the conversation may become focused on a particular detail that is substantially narrower than the previous or original topic. As a result, the current subject of messages may inaccurately represent the current content of the conversation.

One or more embodiments generate subjects for electronic conversations that accurately describe the current content of the conversations. As used herein, the term “subject” refers to the topic, intent, or content of a conversation, which may be described in various formats. For example, a subject may be described by a subject line and, optionally, one or more tags. The subject line is human-readable text string that describes the topic, intent, or content of the conversation. Tags are short codes or abbreviations that categorize the intent or content of the conversation. For example, tags can indicate one or more of a topic, a status, and/or a requirement of the conversation.

A system receives an electronic message and stores the message in association with an electronic conversation relating to a particular customer. The system obtains various information associated with the customer and the electronic conversation, including customer rules, customer context information, and past customer interactions. Using the customer rules, context information, and interactions, the system generates prompts for a machine learning model trained to generate accurate subject lines and/or one or more tags appropriate for particular customers. By submitting the prompts to the machine learning model, the system generates one or more subject lines and/or tags that accurately describe the current topic, intent, and/or content of the conversation.

One or more embodiments update the subject line and/or tags associated with a conversation without requiring human approval of the update; thus, the system may keep subjects up-to-date with little or no human intervention required. Alternatively or additionally, one or more embodiments present the system-generated subject line and/or subject tags to an agent or other user for review via a computer-user interface. In the interface, the agent can determine whether or not to approve the system-generated subject line and/or tags. In some cases, the system may update the current subject line and tags with the system-generated subject line and/or tags. In other cases, the system may present a set of optional subject lines, including at least one system-generated subject line and/or tag and the current subject line for selection by the agent. If the agent does not approve or select the system-generated subject line and/or tags, the system retains the current subject line of the electronic conversation. Additionally, or alternatively, if the agent inputs a different subject line, the system updates the conversation with the agent-generated subject line and/or tags. Also, the system may use the subject line and/or tags approved or input by the agent to further train the machine learning model to improve the model's performance. Furthermore, the system may use the approved subject line and/or tags to log the conversation in a storage system. Subsequently, the system may use the subject line and/or tags when searching and retrieving related conversations from the storage. Furthermore, the system may use various combinations of the words in the subject line and/or tags to filter the stored conversations.

One or more embodiments described in this Specification and/or recited in the claims may not be included in this General Overview section.

### 2. Practical Applications, Advantages & Improvements

Embodiments in accordance with the present disclosure enhance the performance of systems involving electronic messaging by improving data retrieval, data integrity, and system performance. A computing system's efficiency, accuracy, and reliability may be substantially reduced by storing, searching, and/or retrieving electronic conversations with inaccurate subjects. For example, a service management system may include a large database that stores information such as customer accounts, incident logs, product descriptions, and service/repair notices. Because the various sources of information are interdependent, the inaccurate subject lines may cause the customer service management system to fail at locating or retrieving information that is relevant to a customer's incident.

Embodiments enhance data retrieval of electronic messaging systems by generating accurate subject lines and, optionally, one or more tags that enable the systems to better organize and retrieve information. For instance, if a conversation relating to a particular service issue for a particular customer is mislabeled, a query designed to retrieve conversations related to that particular service issue for that specific customer might return incomplete or irrelevant data. If a query returns incomplete or irrelevant data, another query may be required to continue searching for the desired communications, thus requiring more computing resources and placing a greater demand on the system than if the initial query had successfully returned the desired communications. Additionally, when the system attempts to retrieve the mislabeled conversation for the same or similar problem in relation to a different customer, the system may expend excessive computing resources to retrieve the related conversation of the first customer.

Embodiments also enhance data integrity of electronic messaging systems by improving relationships and dependencies between different information sources. For example, a customer record may be linked to several conversations and service tickets. If the subject line is mislabeled, the system may lose track of the connections between different messages and other information. Furthermore, embodiments enhance the performance of electronic messaging systems by improving the labeling of conversations. When the content of subject lines is inaccurate, the system may need to perform additional operations to identify and retrieve the correct records, such as running multiple queries or applying complex filtering logic. This additional processing slows down the system, leading to longer response times and affecting the performance of other dependent systems or applications. Moreover, having accurate subjects and/or tags for current conversations increases productivity for agents or other collaborators included in conversations.

### 3. Service Management Architecture

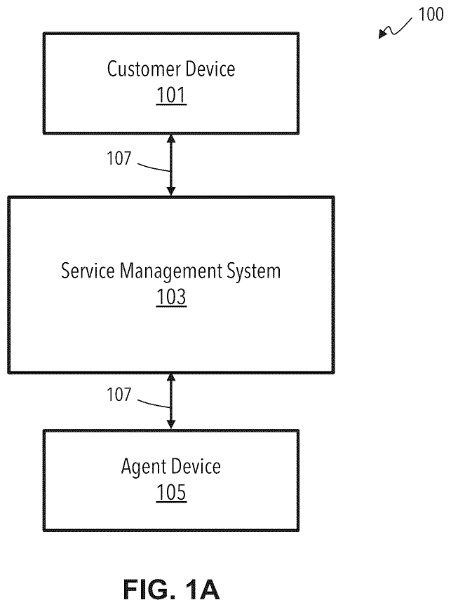

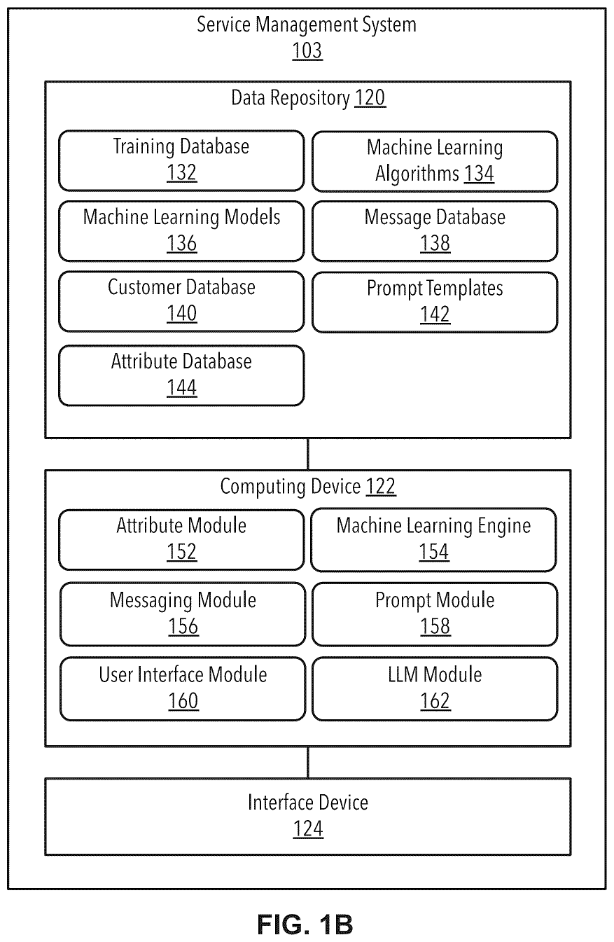

FIG. 1A illustrates an example service system architecture 100 in accordance with one or more embodiments. As illustrated in FIG. 1A, the architecture 100 includes a customer device 101, a service management system 103, and an agent device 105 that are communicatively connected, directly or indirectly, via one or more communication links 107. In one or more embodiments, the architecture 100 includes more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Embodiments of the architecture 100 include a computing environment that manages customer service processes, such as customer inquiries, issues, and requests. Via the customer device 101, a customer may communicate electronic messages directly or indirectly with the service management system 103 and the agent device 105 over various communication channels (e.g., email, telephone, chat, and social media) using the communication links 107. For example, the customer device 101 may directly communicate with the agent device 105, or the customer device 101 may indirectly communicate with the agent device 105 via the service management system 103. In either case, the service management system 103 captures the messages communicated by the customer device 101, the service management system 103, and the agent device 105.

The communication links 107 include wired and/or wireless information communication channels, such as the Internet, an intranet, an Ethernet network, a wireline network, a wireless network, a mobile communications network, and/or another communication network. For example, the customer device 101 may communicate with the service management system 103 and agent device 105 via the Internet by exchanging data packets through a Wi-Fi or cellular data network connection.

The customer device 101 includes one or more computing devices communicatively linked with the service management system 103 and the agent device 105. The term “computing device” generally refers to any hardware device that includes a processor configured to execute computer-readable program instructions. The customer device 101 may be, for example, a personal computer, workstation, server, mobile device, mobile phone, tablet device, and/or other processing device capable of implementing and/or executing software, applications, program instructions, etc. One or more embodiments of the customer device 101 present a user interface allowing a user to access, perceive, and interact with the service management system 103 and/or the agent device 105. For example, the customer device 101 may execute software, such as a Web browser or client application, that generates a computer-user interface that allows a user of the customer device 101 to interact with an agent directly via the agent device 105 or indirectly via the service management system 103.

The service management system 103 includes one or more computing devices that manage and track interaction between an organization, customers, and customer service agents. Example organizations include a government entity, a telecommunications provider, a financial institution, a service provider, or a retail company. Example customers include individuals who need assistance with a technical, transactional, service, or repair issue. Example customer service agents include a human or a chatbot trained to resolve issues related to the organization's services or products. The computing device may refer to a physical device executing an application or a virtual machine. Examples of the service management system 103 include a computer, a desktop, a server, a web server, or a mainframe. The service management system 103 captures documents, messages, and data from various sources, such as the customer device 101 and the agent device 105, and catalogs the information in a searchable format.

The agent device 105 includes one or more computing devices communicatively linked with the customer device 101 and the service management system 103. The agent device 105 may be a personal computer, workstation, server, mobile device, mobile phone, tablet device, and/or other processing device capable of implementing and/or executing software, applications, program instructions, etc. One or more embodiments of the agent device 105 present a user interface allowing a customer service agent to access, perceive, and interact with a customer via the customer device 101.

### 4. Service Management System

FIG. 1B is a block diagram illustrating an example service management system 103 in accordance with one or more embodiments. The service management system 103 includes hardware and software that perform processes and functions described herein. In one or more embodiments, the service management system 103 includes more or fewer components than the components illustrated in FIG. 1B. The components illustrated in FIG. 1B can be local to or remote from each other. The components illustrated in FIG. 1B can be implemented in software and/or hardware. Components can be distributed over multiple applications and/or machines. Multiple components can be combined into one application and/or machine. Operations described with respect to one component can instead be performed by another component.

One or more embodiments of the service management system 103 include a data repository 120, a computing device 122, and an interface 124. The data repository 120 includes any type of storage unit and/or device (e.g., a file system, database, collection of tables, or any other storage mechanism) for storing data. Furthermore, the data repository 120 may include multiple different storage units and/or devices. The multiple different storage units and/or devices may or may not be of the same type or are located at the same physical site. Furthermore, the data repository 120 can be implemented or executed on the same computing system as the service management system 103. Additionally, or alternatively, the data repository 120 may be implemented or executed on a computing system separate from the service management system 103. The data repository 120 can be communicatively coupled, wired and/or wirelessly, to the service management system 103 via a direct connection or via a network. In one or more embodiments, the data repository 120 stores a training database 132, machine learning algorithms 134, a machine learning models 136, a message database 138, a customer database 140, prompt templates 142, and an attribute database 144.

The training database 132 is one or more data structures that stores organized sets of training data for training the machine learning models 136. Based on the training data, a machine learning model learns patterns and correlations in the training data that would be unapparent or unrecognizable to humans for generating subject lines and/or tags describing electronic conversations. As described in greater detail below, the training data may include customer rules, context information, and content of electronic messages. The training data may also include recommended subject lines and/or tags corresponding to individual conversations that serve as target examples for training the machine learning model.

The machine learning algorithms 134 are one or more algorithms that iteratively train a particular machine learning model 136 to map a set of input variables to an output variable. More specifically, the machine learning algorithms 134 are configured to train the machine learning model to generate prompts for subject lines and/or tags based on a given set of customer rules, context, content, and other attributes associated with conversations. A machine learning algorithm may be iterated to train a target model f that best maps a set of input variables to an output variable using the training data. The training data includes datasets and associated labels. The datasets are associated with input variables for the target model f. The associated labels are associated with the output variable of the target model f. The training data may be updated based on, for example, feedback on the predictions by the target model f and accuracy of the current target model f. Updated training data is fed back into the machine learning algorithm that, in turn, updates the target model f.

A machine learning algorithm generates a target model f such that the target model f best fits the datasets of training data to the labels of the training data. Additionally, or alternatively, a machine learning algorithm generates a target model f such that when the target model f is applied to the datasets of the training data, a maximum number of results determined by the target model f matches the labels of the training data. Different target models may be generated based on different machine learning algorithms and/or different sets of training data.

A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

The machine learning models 136 are software trained to make predictions, recognize patterns, or perform tasks without being explicitly programmed for specific decisions. One or more of the machine learning model 136 are trained to generate prompts for a Large Language Model (LLM) to cause the LLM to output subject lines and, optionally, one or more tags reflecting a conversation based on the customer rules, context information, conversation content, and target prompt inputs. Additionally, one or more of the other machine learning models 136 generates conversation subject lines and/or tags that reflect the content, context, and specific attributes of customer messages.

The message database 138 is one or more data structures storing electronic messages sent by customers, agents, and/or the service management system 103 in association with respective conversations. The message database 138 stores electronic messages captured by the service management system 103 along with corresponding metadata of the messages. The messages may be, for example, customer inquiries, agent responses, inter-agent communications, and other such communications. The metadata may include the dates, times, customer identifications, and sources of the messages. By cataloging the messages, the message database 138 allows individual messages and conversations to be labeled, organized, searched, and accessed based on subject, tags, and other information.

The customer database 140 is one or more data structures that stores and organizes customer information. The customer information may include customer profiles, such as names, descriptions, contact information, and histories. The customer information may also include rules, such as policies, standards, constraints, formats, content, and permissible tags for subject lines. The customer information may further include customer documents, such as service level agreements (SLAs), guidelines, and manuals. Additionally, the customer information may record past customer interactions, such as service requests, support tickets, and feedback associated with individual customers.

The prompt templates 142 are one or more data structures that store templates for prompting a large language model (LLM) to generate specific types of responses from the LLM. One or more of the prompt templates 142 causes the LLM to generate subject lines and/or tags tailored for particular customers'context and rules based on, for example, individual customers' previous interactions, past behavior patterns, or past conversations. An example prompt template includes one or more fields, such as rule fields, context fields, and content fields, for integrating one or more output of a machine learning model into a prompt for submission to the LLM.

The attribute database 144 stores attributes used by the machine learning models 136. The attributes include relevant data extracted from other databases, such as the training database 132, the message database 138, and the customer database 140, and stores the attributes in a structured format compatible for input to the machine learning models 136. Examples of stored attributes may include customer information (such as profiles, demographics and identifiers), message (such as extracted content and metadata), and training data features (such as labeled prompts outputs).

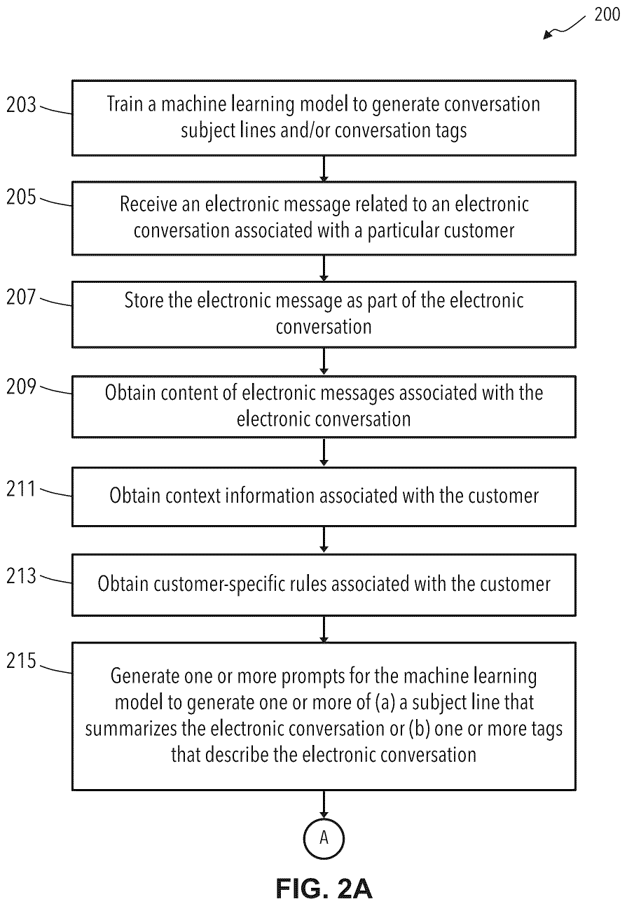

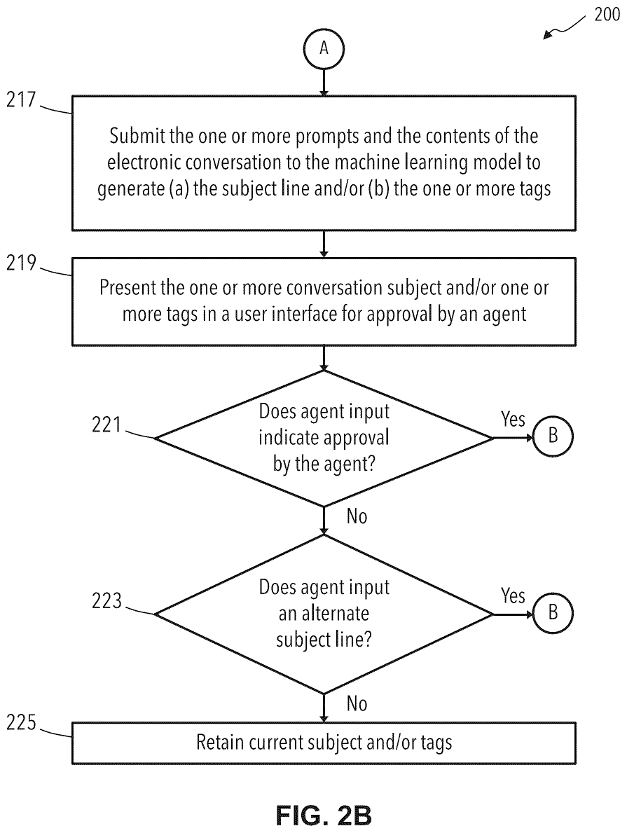

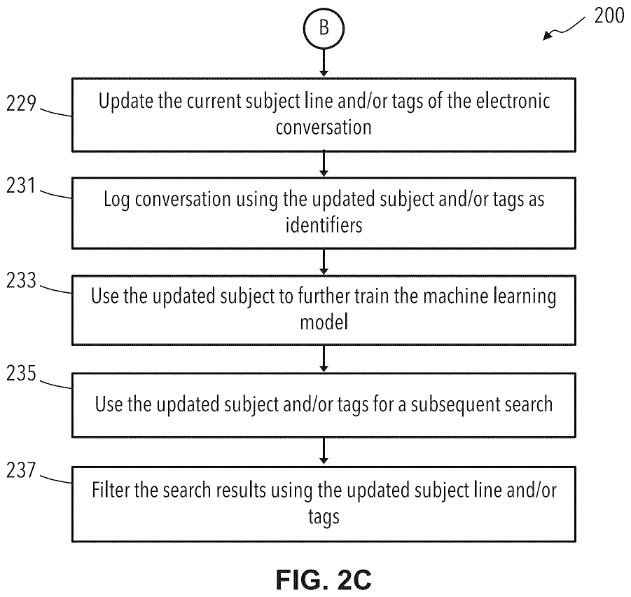

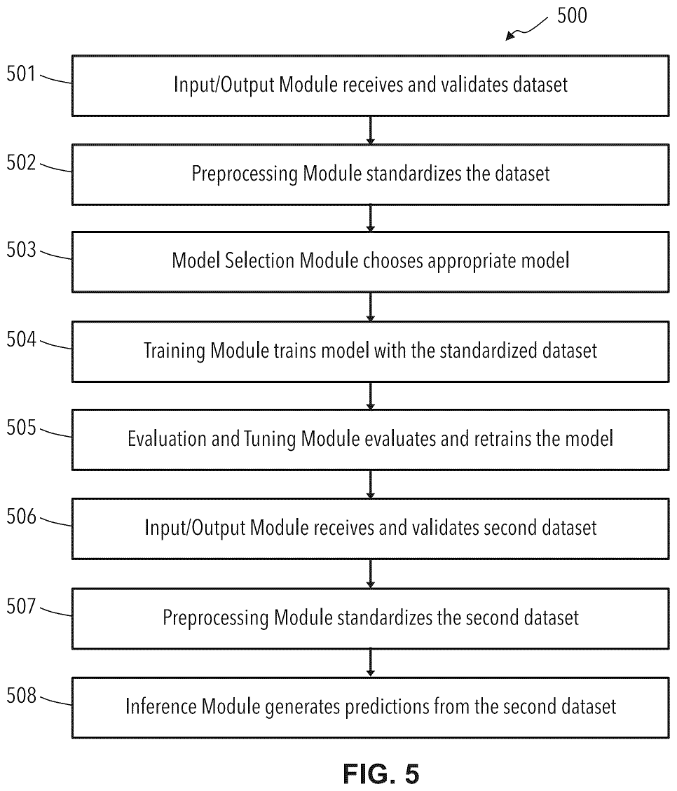

In one or more embodiments, the computing device 122 includes hardware and/or software configured to perform operations described herein. Example operations are described below with reference to FIGS. 2A, 2B, 2C, and 5. The computing device 122 executes computer-readable program instructions, such as an operating system and application programs, that are stored in memory devices and/or the storage system. Additionally, the computing device 122 executes program instructions of an attribute module 152, a machine learning engine 154, a messaging module 156, a prompt module 158, a user interface module 160, and an LLM module 162.

The attribute module 152 generates attributes for the machine learning model 136 and stores the attributes in the attribute database 144. The attribute module 152 obtains data from the training database 132, the message database 138, and/or the customer database 140 for generating the attributes for processing by the machine learning models 136. For example, the attribute module 152 may extract, standardize, and organize the attributes in the attribute database 144.

The machine learning engine 154 may execute a machine learning algorithm 134 to train a machine learning model 136. For example, the machine learning engine 154 may retrieve attributes stored by the attribute database 144 and convert the attributes to feature vectors to generate computer-readable features optimized for the machine learning algorithms 134 and/or the machine learning models 136. Using the feature vectors, the machine learning engine 154 trains the machine learning model to create prompts for an LLM, such as Generative Pre-trained Transformer (GPT) or Bidirectional Encoder Representations from Transformers (BERT) for generating the subject lines and/or tags.

The messaging module 156 captures and catalogs electronic messages communicated between the service management system 103, customers, and/or agents. Example electronic messages include emails, text messages, chat messages, voicemails, video messages, or social media posts. Individual electronic messages may be part of a conversation involving, for example, a customer service request, agent responses, or updates on service requests. The messaging module 156 logs individual messages and corresponding metadata as part of the conversation history.

The prompt module 158 generates prompts that, when submitted to an LLM, causes the LLM to determine accurate and relevant subject lines for customer conversations. For customer interactions, such as an email or chat, the prompt module 158 retrieves customer-specific rules, contextual information, and conversation messages from the message database 138 and the customer database 140. In addition, the prompt module 158 may invoke the attribute module 152 to extract specific attributes from the retrieved customer rules, context information, and conversation messages. Furthermore, the prompt module 158 may invoke an LLM module 166 to submit the prompts to an LLM to generate subject lines and/or tags.

The user interface module 160 manages inputs and outputs communicated with the customer device 101 and the agent device 105 via the interface 124. The user interface module 160 processes incoming command inputs and translates the inputs into specific actions. For example, when a customer sends a command or interacts with the user interface, the user interface module 160 interprets these commands, determining the appropriate hardware response that could range from displaying information to executing operational tasks. Additionally, the user interface module 160 manages the display of information on the agent device 105 via the interface 124. For example, the agent device 105 via the interface 124 controls real-time data rendering, status updates, or progress indicators, and it may also handle error messaging if hardware issues are encountered.

The LLM module 162 executes an LLM trained to understand and generate natural language. Some embodiments of the LLM module 162 locally execute the LLM. Some other embodiments interface with an externally executed LLM, such as GPT or BERT.

The interface 124 refers to hardware and/or software that facilitates communications between a user and agents. The interface 124 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In an embodiment, different components of interface 124 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 124 is specified in one or more other languages, such as Java, C, or C++.

### 5. Updating Electronic Conversations with Subject Lines and Tags Representing the Content of the Conversations

FIGS. 2A, 2B, and 2C illustrate an example set of operations 200 for updating electronic conversations with subject lines and tags representing the content of the conversations. One or more operations illustrated in FIGS. 2A, 2B, and 2C may be modified, rearranged, or omitted. Accordingly, the particular sequence of operations illustrated in FIGS. 2A, 2B, and 2C should not be construed as limiting the scope of one or more embodiments.

The system trains a machine learning model to generate conversation subject lines and/or tags (Operation 203). One or more embodiments train the machine learning model to generate prompts for submission to an LLM, such as GPT or BERT. Training the machine learning model includes generating a training data set including attributes of conversations extracted from one or more of (a) rules associated with customers, (b) context data associated with the customers, and (c) contents of the conversations associated with the customers. One or more other embodiments train a machine learning model to generate subject lines and, optionally, one or more tags based on the customer rules, context, and content. The machine learning model can be, for example, a neural network, a sequence-to-sequence model, a linear regression algorithm, or a random forest algorithm that learns patterns by analyzing the relationships between the attribute in the training data. The individual conversations may be labeled with accurate subject lines and/or tags as targets for training the machine learning model.

The training dataset may include rules, context, and content extracted from databases storing customer-specific information using NLP and image recognition techniques. Additionally, the training dataset may include target prompts corresponding to the conversations representing the accurate outputs for the machine learning model. The target prompts may be obtained from or selected by subject matter experts based on the respective rules, context, and content of conversations included in the training data set.

The customer rules include logical and heuristic rules of customers for generating subject lines and/or tags. The rules correspond to individual customers and specify the scope and constraints of the subject lines to be generated by the system. Example rules specify various parameters for generating subject lines, including the following: if the system should automatically update subject lines; the time frame to consider for including conversation and context information; the number of previous messages in the conversation to review or include when generating updated subject lines; the number of exchanges in a conversation or dialog before an updated subject line is generated; if tags should be appended to the subject line; contexts that should be excluded from the subject lines; a number of tags to generate; and the maximum length of the subject line. The rules may also specify constraints, such as the maximum length of the subject line and a vocabulary of permitted tags.

The context information includes data associated with the particular customer for interpreting the content of the customer's electronic conversations. The context information may include historical information, such as the customers'previous interactions, past behavior patterns, or past conversations. The context information may also include customer-specific profiles, vocabulary, documents, notes, libraries, and the like. Example customer profile data includes service provider and/or customer types (e.g., individual, business, or government, etc.), customer importance (e.g., size, revenue, or spend), preferred languages, preferred communication channels, and customer value (e.g., small, large, or “most valuable player” (MVP)). Example customer documents include software license agreements (SLAs), support agreements, terms of service, manuals, Frequently Asked Questions (FAQs), and the like. The context information can be stored locally by the system or retrieved from a remote storage system.

The content of the electronic conversations includes the subject lines, tags, and body of electronic messages included in the conversations. The content can include text, images, audio, and video, along with metadata thereof. The system can extract content from subjects, tags, message bodies, and metadata of conversations using natural language processing (NLP) techniques. Additionally, the system can extract content from multimedia content, such as images, audio recordings, and videos, using image recognition techniques.

Training the machine learning model also includes computing feature vectors using the training data and labels and feeding the feature vectors from the training dataset to a machine learning algorithm. The algorithm learns to identify elements in the conversation content that, when combined with the context information and rules, are most likely to influence the prompt, subject line, and/or tag. During training, the model is evaluated and adjusted. The system measures the accuracy of the model's predictions against the labeled data in the dataset (e.g., target prompts, subject lines, and tags). Additionally, the system may use a subset of the training data to verify that the output of the machine learning model is sufficiently accurate by comparing the generated prompts, subject lines, and tags output of the model to the verification examples. Evaluation metrics like Bilingual Evaluation Understudy (BLEU) Score or Recall-Oriented Understudy for Gisting Evaluation (ROUGE) score can be applied to assess the quality of the outputs. One or more embodiments integrate the customer rules into the output of the trained machine learning model as post-processing steps. For example, a pointer-generator network may selectively incorporate particular words (e.g., customer names and product identifier) from the input sequence to the subject line. Additionally, if a generated subject line exceeds a customer's character or token limit, the model may truncate the subject to fit within the limit.

The system receives an electronic message related to an electronic conversation associated with a particular customer (Operation 205). As described above, the electronic message may be an email, text message, chat message, voicemail, video message, social media post, or the like. The electronic message may be part of a series of communications between the customer and the system including a conversation involving various exchanges of information, inquiries, or responses. In the context of an example customer service system, the electronic message may be an email from a customer to one or more customer service agents (e.g., one or more human agents and/or chatbots) as part of an ongoing dialog regarding a product. For example, the email may be a response from the customer to the agent regarding a proposed resolution to a product failure.

The system stores the electronic message as part of the electronic conversation (Operation 207). The system combines the received electronic message with related messages previously sent or received as part of the conversation. For example, the system may add the message to a log including a chronological record of the related messages in the conversation. The system may employ various techniques to identify the association between the electronic message and the conversation. The system may use information, such as a customer identifier, subject line, and message identifier, to match the message with an existing customer data (e.g., customer profile) in the database or create a new conversation if an existing conversation is not identified. Additionally, the system may parse the subject line or body of the message for tags, ticket numbers, prefixes, customer identifiers, or other references to previous conversations. Moreover, the system may analyze the content of the message using NLP or an LLM to identify keywords and phrases matching those from previous messages. Furthermore, the system may analyze metadata, such as timestamps, to align the time of the message in the sequence of messages.

The system obtains the contents of the electronic conversation (Operation 209). As described above, the content of the electronic conversation may include the subject lines, tags, content, and metadata of messages included in the conversation. The content can include text, images, audio, and video, along with metadata thereof. The system can extract the content using NLP techniques and image recognition techniques such as optical character recognition (OCR).

The system obtains context information associated with the particular customer (Operation 211). The context information may be retrieved from local, remote, and/or customer storage systems. As described above, the context data includes information of the particular customer for interpreting the content of electronic conversations. The context information can be a set of information including customer-specific documents, messages, metadata, customer notes, policies, agreements, and tags. For example, the context information may include electronic messages of previous conversations with the customer regarding similar products or issues.

The system obtains a set of customer-specific rules associated with the particular customer (Operation 213). The customer-specific rules may be retrieved from local, remote, and/or customer storage systems. As described above, the customer-specific rules may include logical and heuristic rules that specify the scope of material and the format of system-generated subject lines. For example, based on the customer rules, the system may limit the content to a recent time frame or quantity of recent messages. Additionally, the rules may specify tags to be included in subject lines.

The system generates one or more prompts for a machine learning model to generate one or more of (a) a subject line that summarizes the electronic conversation and (b) one or more tags that describe the electronic conversation (Operation 215). Generating a prompt includes extracting the customer rules, context data, and content of the electronic conversation for inclusion in a prompt. Some embodiments generate a single prompt to determine a single subject. Some other embodiments generate multiple alternate prompts to determine multiple alternate subjects. To generate the alternate prompts, the system may use alternate prompt templates. Additionally, or alternatively, the system may generate alternate phrasing for a single prompt template by, for example, extracting different terms from the context of the conversation.

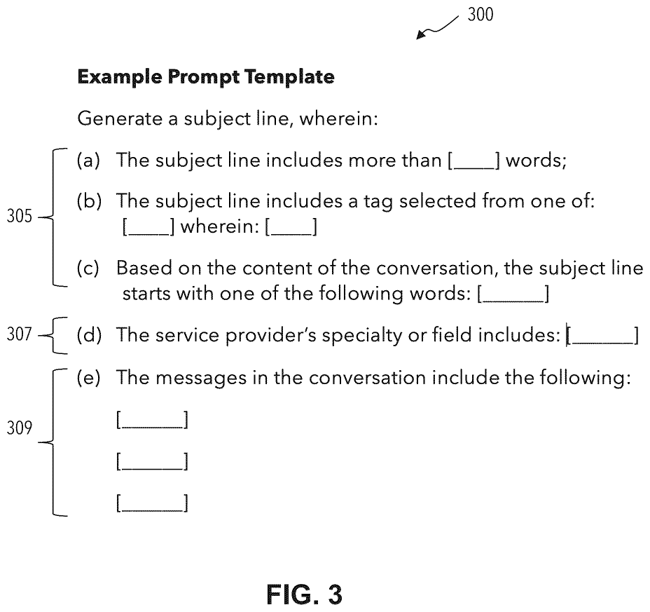

Some embodiments use prompt templates with predefined sections to be filled with relevant information extracted from the customer rules, context data, and the content of the electronic conversation. For example, FIG. 3 illustrates an example prompt template including one or more rule fields 305, context fields 307, and content fields 309. The rule fields 305 define parameters guiding the subject line's scope, size, and content. The rules may specify customer-specific tags relevant to the subject line. The tags may represent various information, such as product types, service categories, issue types, and security considerations, among others. Tags may include indicators of priority, issue complexity, communication channel, geographic location, or specialty (e.g., technical support, billing, or customer relations). The tags may also identify the interaction history (e.g., follow-up request, repeat issue, or new inquiry), or specific compliance requirements (e.g., Health Insurance Portability and Accountability Act, “HIPAA”). Security-related tags could also identify potential issues, such as indicators of a data breach or social engineering attempt. The context fields 307 may identify specific service and issue background related to the service provider, customer, and conversation topic. For instance, the context fields 307 could define that the provider specializes in repairs, and the issue may involve a request for an on-site repair service by a technician. The content fields 309 include content of messages within the customer conversation as specified by customer preferences. For example, the customer preference may specify a time frame for the messages used to generate subject lines and/or tags to constrain the content to recent and relevant messages.

Referring to FIG. 2B, as indicated by off-page connector “A,” the system submits the one or more prompts and the contents of the electronic conversation to the machine learning model to obtain (a) the conversation subject line and/or (b) the one or more tags (Operation 217). Once the sections of the prompt template are populated, the completed template is submitted as an input that causes the LLM to generate relevant subject lines and/or tags. After the model generates a subject line and/or tags, the system may apply additional post-processing steps to ensure the output meets the customer rules. For example, if the generated subject line exceeds a specified quantity of words, the system may truncate the subject line. Additionally, the system may add any tags specified by the rules. For example, the rules may indicate that electronic messages with certain valuable customers be tagged as “MVP.”

The system presents the one or more conversation subject lines and/or one or more tags in a user interface for approval by an agent (Operation 219). Some embodiments automatically (e.g., without requiring user approval) update the current conversation subject line and/or tags with the system-generated subject line. Other embodiments present the one or more system-generated subject line and/or tags to the agent via a GUI for review and approval. For example, the system may display the current subject line and one or more system-generated subject lines using a GUI at an agent device. In the context of an example customer service system, a GUI may include an agent dashboard that displays a centralized view of customer conversations, allowing the agent to manage and respond to messages. The agent may select a specific conversation to address from a list of pending customer messages displayed by the dashboard. Once the conversation is selected, the system loads and displays the customer's message. Alongside the message, the system presents a dialog window that offers the current subject line and one or more conversation subject lines and/or tags generated by the system for the agent to choose from. The dialog window also includes a text entry field, allowing the agent to input a different subject line and/or tags based on the agent's judgment and expertise. The agent's input is then used to refine and update the subject line and tags associated with the conversation.

The system determines if the agent input indicates approval of the subject line and/or the one or more tags by the agent (Operation 221). Some embodiments include interactive graphic elements, such as a Yes/No selection, checkboxes or radio buttons, in the agent dashboard for receiving the agent's approval and rejection of the subject line and/or tags. For example, after considering the relevance and appropriateness of the subject line in the context of the customer's message and the overall conversation, the agent may enter an input to the GUI accepting the subject line and/or the one or more tags. If the agent indicates approval of the subject line and/or one or more tags (Operation 221 is “Yes”), then the process 200 proceeds to FIG. 2C (Operation 229) as indicted by off-page connector “B”and as described below.

If the user does not indicate approval of the subject line and/or one or more tags (Operation 221 is “No”), then the system determines if the agent input an alternate subject line and/or tag via the GUI (Operation 223). Some embodiments include a text entry field in the agent dashboard for receiving the alternate subject line. For example, the agent may use the text entry field to manually input a different subject line that better represents with the current content of the conversation. Additionally, or alternatively, the agent may modify or edit the system-generated subject and/or tags. For example, the agent may manually add a tag via the text entry field. In such cases, the system may use the modified subject line and conversation context information to further train the machine learning model as described below.

If the agent inputs an alternate subject line and/or tag (Operation 223 is “Yes”), then the process proceeds to FIG. 2C (Operation 229) as indicated by off-page connector “B”. If the agent does not input an alternate subject line (Operation 223 is “No”), then the system retains the current subject line and/or tags (Operation 225). Retaining the original subject line and tags for the conversation includes forgoing modifications to the conversation and proceeding with the original subject and tags intact.

Referring to FIG. 2C, as indicated by off-page connector “B,” the system updates the current subject line with the system-generated subject line, and/or tags, or the agent's alternate subject line (Operation 229). Updating the subject line and tags may include replacing the current subject line and tags in the message and/or in the conversation. The system initiates the logging of the conversation by utilizing the updated subject line and/or tags as identifiers (Operation 231). Logging the conversation may involve recording the conversation within the system's database, ensuring that the conversation is associated with the system-generated subject line and/or tags as identifiers. When the conversation has already been recorded in the log (e.g., for an open service request), the system modifies or updates the existing log with the updated subject line and/or tags as identifiers. The identifiers serve as reference points, allowing the system to organize and categorize the conversation for future search and retrieval. Additionally, logging the conversation may include revising metadata of the messages within the conversation to include the updated subject line and/or tags. By doing so, the system improves the accuracy of the information in the log for efficient search and retrieval.

One or more embodiments use the system-generated subject line and/or tags, or the agent-generated subject line, and/or one or more tags to further train the machine learning model (Operation 233). The system records the changes made by the system or the agent, including the specific alterations to the subject lines or tags, as well as the context data of the conversation. The computing system then integrates this feedback into the model's training process by creating new training examples that pair the original model outputs with the agent-modified versions. During a subsequent training cycle, the model is retrained using the augmented dataset that now includes the agent-modified examples. The system adjusts the model's parameters to minimize the differences between the model's outputs and the agent-provided feedback. The system may also update or refine the rules, context data, or content analysis based on patterns identified in the agent feedback, further enhancing the model's performance.

After updating the conversation, the system may use the logged subject line and/or tags for searching and retrieving messages in the conversation. More specifically, the system searches the storage system using the updated identifiers as search criteria (Operation 235). The system may then retrieve relevant records, documents, or previous conversations that match the identifiers of the updated subject line and/or tags. Additionally, the system filters the search results using the subject line and/or tags (Operation 237). The filtering process narrows down the search results to ensure that the most relevant messages are surfaced, thus optimizing the retrieval process and improving data management within the system.

### 6. Example Embodiment

An example embodiment is described below for purposes of clarity. Components and/or operations described below should be understood as one specific example that may not be applicable to certain embodiments. Accordingly, components and/or operations described below should not be construed as limiting the scope of any of the claims.

In the non-limiting example, the system may be a customer service system involving communications between customers and customer service agents of a service entity. The system may track service requests, referred to as “incidents,” using a ticketing system that associates related tickets to a lifecycle of the incident. The incident captures messages included in the conversation between a customer and a customer service representative. Additionally, the incident captures internal communication among agents about the customer's issue, steps taken to resolve the issue, a timeline of interactions, the customer name, and service history, etc.

As a customer and customer service agents exchange electronic messages to resolve the incident, the original subject of the messages may not accurately capture the evolving conversation. For example, when the incident was created, the agent may have labeled the electronic messages with a subject line and/or tags that identify the issue or topic of conversation included in that incident. However, after several electronic messages have been exchanged, the content evolves over time, eventually causing the incident content to diverge from the original subject. A second agent who is subsequently added to the incident may find the original subject to be misleading and disconnected with the current topic. Similarly another agent searching for the incident by subject may not be able to find the incident because the subject line does not accurately reflect the content of the conversation.

In accordance with aspects of the present disclosure, the example system uses an LLM to generate a subject line and, optionally, one or more tags for the digital artifact that accurately reflect the communications of the incident. Some embodiments trigger the generation of subject line and/or tags after a predetermined number of messages or interactions occur in an incident. The system submits to the LLM relevant information about the digital communication and constructs a prompt to cause the LLM to determine a subject for the incident that accurately reflects the information fed to the LLM, including the customer rules, context information, and the content of the conversation. Also, the prompt may include an option for the LLM to choose the current subject if it is accurate. The prompt may specify a maximum size for the short descriptor to ensure that the subject will not exceed data validation constraints that may exist in the subject or title field. The prompt may also include rules specifying customer-specific constraints for the subject line. Furthermore, the prompt may also include rules specifying certain tags, such as “MVP,” at the beginning of the subject line involving an important customer.

The system may automatically update to the system-generated subject or present the generated subject line and/or tags to the agent for their confirmation/acceptance via a computer-user interface. In the interface, the agent can determine whether or not to approve the system-generated subject line and/or tags. In some cases, the agent may revert to the previous subject line by rejecting the system-generated subject line. In other cases, the interface may present optional subject lines for selection by the agent via the interface. The optional subject lines may include the one or more system-generated subject lines and the current subject line. Additionally, or alternatively, the interface may include an text-entry region for the agent to input a different subject line.

### 7. Machine Learning Architecture

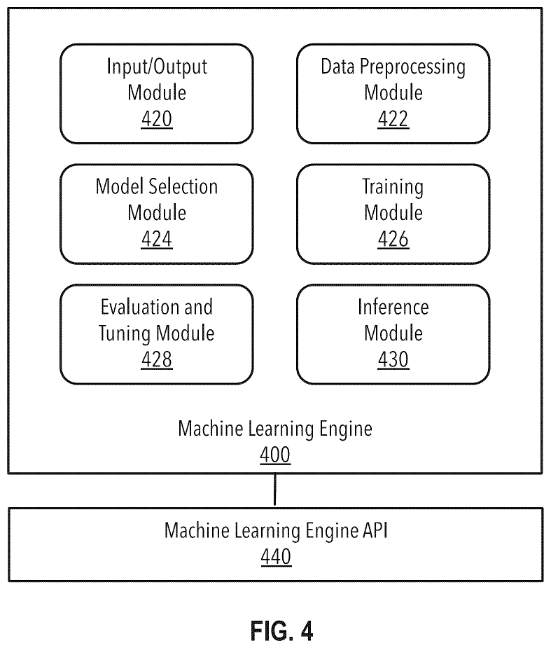

FIG. 4 illustrates a machine learning engine 400 in accordance with one or more embodiments. The machine learning engine 400 may be the same or similar to the machine learning engine previously described above. As illustrated in FIG. 4, machine learning engine 400 includes input/output module 420, data preprocessing module 422, model selection module 424, training module 426, evaluation and tuning module 428, and inference module 430.

In accordance with an embodiment, input/output module 420 serves as the primary interface for data entering and exiting the system, managing the flow and integrity of data. This module may accommodate a wide range of data sources and formats to facilitate integration and communication within the machine learning architecture.

In an embodiment, an input handler within input/output module 420 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 420 to be versatile in different operational contexts, whether processing historical datasets or streaming data.

In accordance with an embodiment, input/output module 420 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 420 includes an output framework designed to handle the distribution and exportation of outputs, predictions, or insights. Using the output framework, input/output module 420 formats these outputs into user-friendly and accessible formats, such as reports, visualizations, or data files compatible with other systems. Input/output module 420 also ensures secure and efficient transmission of these outputs to end-users or other systems in an embodiment and may employ encryption and secure data transfer protocols to maintain data confidentiality.

In accordance with an embodiment, data preprocessing module 422 transforms data into a format suitable for use by other modules in machine learning engine 400. For example, data preprocessing module 422 may transform raw data into a normalized or standardized format suitable for training machine learning models and for processing new data inputs for inference. In an embodiment, data preprocessing module 422 acts as a bridge between the raw data sources and the analytical capabilities of machine learning engine 400.

In an embodiment, data preprocessing module 422 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 422 may be configured to handle anomalies in different ways depending on context. Data preprocessing module 422 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 422 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 422 processes new data for inference, data preprocessing module 422 replicates the same preprocessing steps to ensure consistency with the training data format. This helps to avoid discrepancies between the training data format and the inference data format, thereby reducing the likelihood of inaccurate or invalid model predictions.

In an embodiment, model selection module 424 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 424 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 424 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 424 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 424 also considers computational efficiency and resource constraints. This is meant to help ensure the selected model is both accurate and practical in terms of computational and time requirements. In an embodiment, certain features of model selection module 424 are configurable such as a configured bias toward (or against) computational efficiency.

In accordance with an embodiment, training module 426 manages the ‘learning’ process of machine learning models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 426 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 426 manages overfitting, where a model learns the training data too well, including its noise and outliers, at the expense of its ability to generalize new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 426 includes logic to handle different types of data and learning tasks. For instance, it includes different training routines for supervised learning (where the training data comes with labels) and unsupervised learning (without labeled data). In the case of deep learning models, training module 426 also manages the complexities of training neural networks that include initializing network weights, choosing activation functions, and setting up neural network layers.

In an embodiment, evaluation and tuning module 428 incorporates dynamic feedback mechanisms and facilitates continuous model evolution to help ensure the system's relevance and accuracy as the data landscape changes. Evaluation and tuning module 428 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 428 performs continuous model tuning by using hyperparameter optimization. Evaluation and tuning module 428 performs an exploration of the hyperparameter space using algorithms, such as grid search, random search, or more sophisticated methods like Bayesian optimization. Evaluation and tuning module 428 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 428 integrates data feedback and updates the model. Evaluation and tuning module 428 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 428 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 428 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 430 transforms data raw data into actionable, precise, and contextually relevant predictions. In addition to processing and applying a trained model to new data, inference module 430 may also include post-processing logic that refines the raw outputs of the model into meaningful insights.

In an embodiment, inference module 430 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 430 transforms the outputs of a trained model into definitive classifications. Inference module 430 employs the underlying model as a tool to generate probabilistic outputs for each potential class. It then engages in an interpretative process to convert these probabilities into concrete class labels.

In an embodiment, when inference module 430 receives the probabilistic outputs from the model, it analyzes these probabilities to determine how they are distributed across some or every potential class. If the highest probability is not significantly greater than the others, inference module 430 may determine that there is ambiguity or interpret this as a lack of confidence displayed by the model.

In an embodiment, inference module 430 uses thresholding techniques for applications where making a definitive decision based on the highest probability might not suffice due to the critical nature of the decision. In such cases, inference module 430 assesses if the highest probability surpasses a certain confidence threshold that is predetermined based on the specific requirements of the application. If the probabilities do not meet this threshold, inference module 430 may flag the result as uncertain or defer the decision to a human expert. Inference module 430 dynamically adjusts the decision thresholds based on the sensitivity and specificity requirements of the application, subject to calibration for balancing the trade-offs between false positives and false negatives.

In accordance with an embodiment, inference module 430 contextualizes the probability distribution against the backdrop of the specific application. This involves a comparative analysis, especially in instances where multiple classes have similar probability scores, to deduce the most plausible classification. In an embodiment, inference module 430 may incorporate additional decision-making rules or contextual information to guide this analysis, ensuring that the classification aligns with the practical and contextual nuances of the application.

In regression models, where the outputs are continuous values, inference module 430 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 430 incorporates domain-specific adjustments into its post-processing routine. This involves tailoring the model's output to align with specific industry knowledge or contextual information. For example, in financial forecasting, inference module 430 may adjust predictions based on current market trends, economic indicators, or recent significant events, ensuring that the outputs are both statistically accurate and practically relevant.

In an embodiment, inference module 430 includes logic to handle uncertainty and ambiguity in the model's predictions. In cases where inference module 430 outputs a measure of uncertainty, such as in Bayesian inference models, inference module 430 interprets these uncertainty measures by converting probabilistic distributions or confidence intervals into a format that can be easily understood and acted upon. This provides users with both a prediction and an insight into the confidence level of that prediction. In an embodiment, inference module 430 includes mechanisms for involving human oversight or integrating the instance into a feedback loop for subsequent analysis and model refinement.

In an embodiment, inference module 430 formats the final predictions for end-user consumption. Predictions are converted into visualizations, user-friendly reports, or interactive interfaces. In some systems, like recommendation engines, inference module 430 also integrates feedback mechanisms, where user responses to the predictions are used to continually refine and improve the model, creating a dynamic, self-improving system.

FIG. 5 illustrates an example set of operations 500 for a machine learning engine 400 in one or more embodiments. In an embodiment, input/output module 420 receives a dataset intended for training (Operation 501). This data can originate from diverse sources, like databases or real-time data streams, and in varied formats, such as CSV, JSON, or XML. Input/output module 420 assesses and validates the data, ensuring its integrity by checking for consistency, data ranges, and types.

In an embodiment, training data is passed to data preprocessing module 422. Here, the data undergoes a series of transformations to standardize and clean it, making it suitable for training machine learning models (Operation 502). This involves normalizing numerical data, encoding categorical variables, and handling missing values through techniques like imputation.

In an embodiment, prepared data from the data preprocessing module 422 is then fed into model selection module 424 (Operation 503). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 426 trains the selected model with the prepared dataset (Operation 504). It implements learning algorithms to adjust the model's internal parameters, optimizing them to identify patterns and relationships in the training data. Training module 426 also addresses the challenge of overfitting by implementing techniques, like regularization and early stopping, ensuring the model's generalizability.

In an embodiment, evaluation and tuning module 428 evaluates the trained model's performance using the validation dataset (Operation 505). Evaluation and tuning module 428 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 420 receives a dataset intended for inference. Input/output module 420 assesses and validates the data (Operation 506).

In an embodiment, data preprocessing module 422 receives the validated dataset intended for inference (Operation 507). Data preprocessing module 422 ensures that the data format used in training is replicated for the new inference data, maintaining consistency and accuracy for the model's predictions.

In an embodiment, inference module 430 processes the new data set intended for inference, using the trained and tuned model (Operation 508). It applies the model to this data, generating raw probabilistic outputs for predictions. Inference module 430 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, machine learning engine API 440 allows for applications to leverage machine learning engine 400. In an embodiment, machine learning engine API 440 may be built on a RESTful architecture and offer stateless interactions over standard HTTP/HTTPS protocols. Machine learning engine API 440 may feature a variety of endpoints, each tailored to a specific function within machine learning engine 400. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 440 is equipped to support SOAP-based interactions. This extension involves defining a WSDL (Web Services Description Language) document that outlines the API's operations and the structure of request and response messages. In an embodiment, machine learning engine API 440 supports various data formats and communication styles. In an embodiment, machine learning engine API 440 endpoints may handle requests in JSON format or any other suitable format. For example, machine learning engine API 440 may process XML, and it may also be engineered to handle more compact and efficient data formats, such as Protocol Buffers or Avro, for use in bandwidth-limited scenarios.

In an embodiment, machine learning engine API 440 is designed to integrate WebSocket technology for applications necessitating real-time data processing and immediate feedback. This integration enables a continuous, bi-directional communication channel for a dynamic and interactive data exchange between the application and machine learning engine 400.

### 8. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

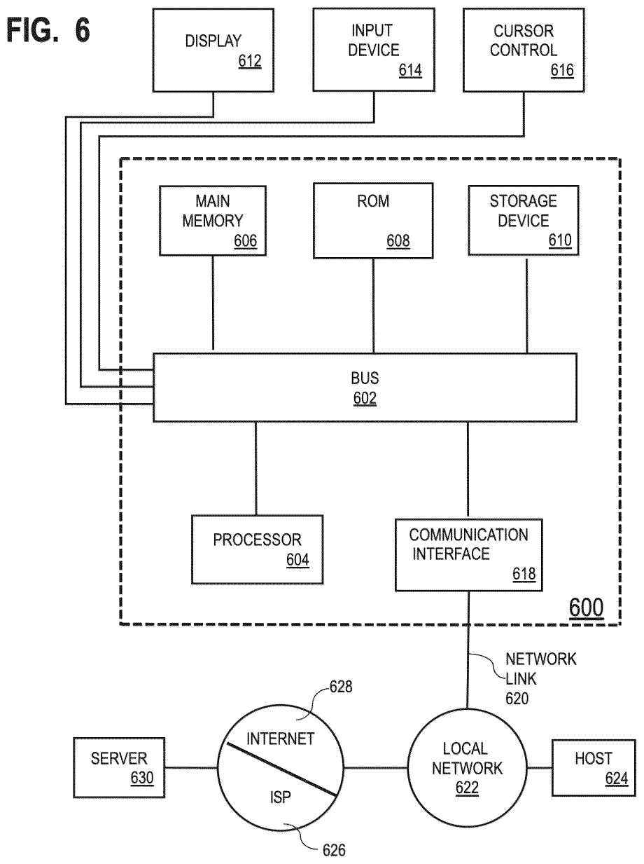

For example, FIG. 6 is a block diagram that illustrates a computer system 600 upon which an embodiment of the disclosure may be implemented. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in non-transitory storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk, optical disk, or a Solid State Drive (SSD) is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### 9. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions that, when executed by one or more hardware processors, cause performance of operations comprising:
receiving a first electronic message comprising at least part of an electronic conversation with a particular customer, the electronic message comprising a current subject that describes the electronic message;
obtaining content information of one or more electronic messages related to the electronic conversation;
obtaining context information associated with the particular customer for interpreting the electronic conversation, wherein the context information comprises customer-specific interactions and data;
generating a prompt for a machine learning model trained to output recommended subjects for electronic conversations, wherein the prompt incorporates the content information and the context information;
applying the machine learning model to the prompt, to obtain a recommended subject;
updating the electronic conversation by replacing the current subject with the recommended subject; and
logging the updated electronic conversation in a database that associates the one or more electronic messages with the recommended subject.

2. The one or more non-transitory computer readable media of claim 1, wherein the operations further comprise:
receiving a search query comprising one or more terms found in the recommended subject but not found in the current subject; and
responsive to the search query: surfacing the updated electronic conversation as a search result.

3. The one or more non-transitory computer readable media of claim 1, wherein the operations
further comprise:
receiving a request to filter a plurality of electronic conversations based on one or more filtering criteria, wherein the one or more filtering criteria comprise at least one criterion associated with the recommended subject but not associated with the current subject; and
responsive to the request: generating a filtered list of electronic conversations comprising the updated electronic conversation.

4. The one or more non-transitory computer readable media of claim 1, wherein the operations further comprise:
presenting the recommended subject to a user via a graphic user interface (GUI); and
receiving approval of the recommended subject from the user via the GUI prior to updating the electronic conversation.

5. The one or more non-transitory computer readable media of claim 1, wherein the operations further comprise:
presenting the recommended subject to a user via a GUI; and
receiving an alternate subject from the user via the GUI prior to updating the electronic conversation;
wherein updating the electronic conversation comprises: replacing the current subject using the alternate subject as the recommended subject.

6. The one or more non-transitory computer readable media of claim 1, wherein the operations further comprise:
obtaining one or more rules associated with the particular customer that specify one or more customer-specific requirements for generating the recommended subject line;
wherein the prompt further incorporates the one or more customer-specific requirements.

7. The one or more non-transitory computer readable media of claim 6 wherein the one or more rules cause the machine learning model to include one or more tags, from a plurality of tags associated with the particular customer, in the recommended subject line.

8. The one or more non-transitory computer readable media of claim 1, wherein the prompt causes the machine learning model to determine (a) first tag of a plurality of tags categorizing the electronic message, and (b) a semantic description of the electronic message.

9. The one or more non-transitory computer readable media of claim 1, wherein the operations further comprise:
determining a difference between tokens included in the recommended subject and tokens included in the subject; and
updating the machine learning model based on a difference between the current subject and the updated subject.

10. A method comprising:
receiving a first electronic message comprising at least part of an electronic conversation with a particular customer, the electronic message comprising a current subject that describes the electronic message;
obtaining content information of one or more electronic messages related to the electronic conversation;
obtaining context information associated with the particular customer for interpreting the electronic conversation, wherein the context information comprises customer-specific interactions and data;
generating a prompt for a machine learning model trained to output recommended subjects for electronic conversations, wherein the prompt incorporates the content information and the context information;
applying the machine learning model to the prompt, to obtain a recommended subject;
updating the electronic conversation by replacing the current subject with the recommended subject; and
logging the updated electronic conversation in a database that associates the one or more electronic messages with the recommended subject.

11. The method of claim 10, further comprising:
receiving a search query comprising one or more terms found in the recommended subject but not found in the current subject; and
responsive to the search query: surfacing the updated electronic conversation as a search result.

12. The method of claim 10, further comprising:
receiving a request to filter a plurality of electronic conversations based on one or more filtering criteria, wherein the one or more filtering criteria comprise at least one criterion associated with the recommended subject but not associated with the current subject; and
responsive to the request: generating a filtered list of electronic conversations comprising the updated electronic conversation.

13. The method of claim 10, further comprising:
presenting the recommended subject to a user via a graphic user interface (GUI); and
receiving approval of the recommended subject from the user via the GUI prior to updating the electronic conversation.

14. The method of claim 10, further comprising:
presenting the recommended subject to a user via a GUI; and
receiving an alternate subject from the user via the GUI prior to updating the electronic conversation;
wherein updating the electronic conversation comprises: replacing the current subject using the alternate subject as the recommended subject.

15. The method of claim 10, further comprising:
obtaining one or more rules associated with the particular customer that specify one or more customer-specific requirements for generating the recommended subject line;
wherein the prompt further incorporates the one or more customer-specific requirements.

16. The method of claim 15, wherein the one or more rules cause the machine learning model to include one or more tags, from a plurality of tags associated with the particular customer, in the recommended subject line.

17. The method of claim 10, wherein the prompt causes the machine learning model to determine (a) first tag of a plurality of tags categorizing the electronic message, and (b) a semantic description of the electronic message.

18. The method of claim 10, further comprising:
determining a difference between tokens included in the recommended subject and tokens included in the subject; and
updating the machine learning model based on a difference between the current subject and the updated subject.

19. A system comprising:
at least one device including a hardware processor;
the system being configured to perform operations comprising:
receiving a first electronic message comprising at least part of an electronic conversation with a particular customer, the electronic message comprising a current subject that describes the electronic message;
obtaining content information of one or more electronic messages related to the electronic conversation;
obtaining context information associated with the particular customer for interpreting the electronic conversation, wherein the context information comprises customer-specific interactions and data;
generating a prompt for a machine learning model trained to output recommended subjects for electronic conversations, wherein the prompt incorporates the content information and the context information;
applying the machine learning model to the prompt, to obtain a recommended subject;
updating the electronic conversation by replacing the current subject with the recommended subject; and
logging the updated electronic conversation in a database that associates the one or more electronic messages with the recommended subject.

20. The system of claim 19, wherein the operations further comprise:
receiving a search query comprising one or more terms found in the recommended subject but not found in the current subject;
responsive to the search query: surfacing the updated electronic conversation as a search result;
receiving a request to filter a plurality of electronic conversations based on one or more filtering criteria, wherein the one or more filtering criteria comprise at least one criterion associated with the recommended subject but not associated with the current subject; and
responsive to the request: generating a filtered list of electronic conversations comprising the updated electronic conversation.
